(19) United States
(12) Patent Application Publication
(10) Pub. No.: US 2010/0289275 A1
(43) Pub. Date: Nov. 18, 2010

(54) Reversible lock follower assembly for a mortise lock

(75) Inventors: George R. Marks, (US); Emil J. Budzioch, (US)

Correspondence Address: LAW OFFICES OF JOHN R. MUGNO, 350 BROADWAY - 10TH FLOOR, NEW YORK, NY, 10013, US

(73) Assignee: Marks USA I, LLC

(21) Appl. No.: 12/454,141

(22) Filed: May 13, 2009

(51) Int. Cl. E05B 15/00

(52) U.S. Cl. 292/245

(57) ABSTRACT

A reversible lock follower assembly for a mortise lock having a housing for accommodating the mortise lock components and a front plate for attachment to an edge of a door is described that allows for selective reversibility of the lock follower assembly without any disassembly of the mortise lock housing. The reversible lock follower assembly comprises: (i) a follower body having a side facing the front plate and an opposite side having a bore; (ii) a coil spring placed in the bore; (iii) a follower ball engaged with the coil spring; (iv) a follower locking piece selectively movable within a slot of the follower body having a spindle hub engaging end and a follower body engaging end; and (v) a first aperture on the follower body engaging end to receive the follower ball when the locking piece is in a first position and a second aperture on the follower body engaging end to receive the follower ball when the locking piece is in a second position. In operation, the installer will move the follower locking piece to one of the first and second positions by accessing the follower locking piece through a cut-out on the housing.

### FIELD OF THE INVENTION

The present invention is generally directed to mortise locks. More specifically, the present invention provides a system and method of reversing a lock follower assembly depending on whether the mortise lock is mounted on a left-hand edge or a right-hand edge of a door. The reversible lock follower assembly and method of the present invention can selectively be accommodated to a left-hand or right-hand door orientation without any disassembly of the housing which contains the components of the mortise lock.

### BACKGROUND OF THE INVENTION

Mortise locks, which are well-known in the art, are designed to fit into a mortised recess on an edge of a door opposite the hinged edge of a door. A mortise lock is generally secured to the edge of the door by a front plate which includes holes (bores) to receive screws that fasten the front plate to the door.

A mortise lock can typically include a latch bolt, a deadbolt, an auxiliary bolt, and a follower assembly (which is typically in the form of a push button or toggle switch). It is well known in the art that the latch bolt and the auxiliary bolt can extend outward beyond the edge of the door and into a recess in a latch plate in the opposing door frame, thereby latching the door in a closed position. Conversely, the latch bolt and auxiliary bolt may be retracted to allow opening of the door. Similarly, a deadbolt is typically independently actuated so that when it is made to extend beyond the edge of the door and into a bore of the latch plate in the opposing door frame, it will be secured in a locked position. Conversely, the deadbolt can also be retracted to allow unlocking of the door.

Although numerous variations are possible, depending on specific and desired applications, mortise locks are typically configured so that the inside door knob can be rotated to retract the latch and the outside door knob can be rotated to either retract the latch or lock to prevent retraction of the latch. Movement of the latch bolt from its extended position to its retracted position is usually mechanically accomplished by means of one of a pair of spindle hubs disposed within the housing, wherein each spindle hub is independently pivotable about a fixed access and each spindle hub has a slot permitting independent engagement and blocking of the two spindle hubs.

The selective manipulation of the two spindle hubs is dependent not only on the desired functionality of the mortise lock, but also on whether the mortise lock is secured to the left-hand edge of the door or the right-hand edge of the door. For instance, if a particular functionality is established for a mortise lock secured to the right-hand edge of a door, the functionality would essentially have to be reversed when the mortise lock was secured to the left-hand edge of the door. Moreover, the physical components such as the latch bolt and auxiliary bolt would also need to be reversed. For instance, the latch bolt would need to be reversed so that its beveled edge still properly engages within the latch plate.

In order to facilitate the installation of mortise locks regardless of what edge of the door the mortise locks are installed, lock manufacturers originally manufactured separate left-hand mortise locks and right-hand mortise locks. However, the non-adaptability of such application-specific mortise locks required installers to maintain an undesirable amount of inventory and often created situations wherein the installer would have to make a second trip to the premises to provide a correctly orientated lock.

As the prior art developed, lock manufacturers began to develop mortise locks that could be reversed to the desired orientation. However, adjustments to such conventional mortise locks typically could only be accomplished by partially or totally disassembling the housing comprising the mortise lock components and rearranging (or configuring) the mortise lock components to achieve the desired mode of operation. Further, the task of disassembling the mortise lock often was a very time consuming process. Moreover, disassembling the mortise lock housing often resulted in damaged or lost mortise lock components. If a component was damaged or lost, the entire mortise lock would have to be replaced.

More recently, lock manufacturers have developed reversible mortise locks wherein the lock components can be reversed with little or no disassembly of the mortise lock housing. Regrettably, such reversible mortise locks typically have required non-conventional and often more expensive lock components, or required special tools to operate. Certain designs also permitted the reversibility through the face plate, which led to instances of tampering of the locks.

Pelletier U.S. Pat. No. 5,678,870 provides a complicated means to reverse a mortise lock. The interfering member or locking piece is manipulated by means of an external spring wire that is mounted to a post in the housing. Regrettably, the spring wire is fragile and easily damaged since it is outside the mortise lock housing. When the spring wire becomes damaged, the mortise lock is no longer reversible.

Moon et al. United States Publication No. 2008/0042452 A1 provides a reversible latch bolt assembly for a mortise lock. The latch bolt assembly comprises a bolt head subassembly having a stem threaded into its rear portion. The bolt head subassembly engages a body portion designed for anchoring the reversible latch bolt assembly inside a door. The stem is inserted distally into an aperture in the body. A rotary selector assembly is mounted in the body orthogonal to the stem aperture and, when the stem is inserted, to selectively engage or disengage the collar of the stem to prevent or allow rotation thereof. The rotary selector assembly is key-operative. Thus, while this design is intended to prevent tampering, it is also complicated to manipulate.

Fayngersh et al. U.S. Pat. No. 6,349,982 provides a reversible latch bolt assembly that includes a specially-designed threaded plug and is manipulated by means of a screw driver. The reversible bolt assembly of this prior art reference also includes numerous small moving parts such as a removable spring, a spring flange, a tail plate, and a spring clip. Such small components are easily broken or misplaced, and also difficult to manipulate.

Hull U.S. Pat. No. 4,583,382 provides a mortise lock with reversible features, but requires duplicative lockable handle means and duplicative lock means to provide such reversibility. The device presented in this prior art reference is both expensive to produce and complicated to operate.

It is therefore a primary object of the present invention to provide a new and improved reversible follower assembly for a mortise lock.

It is another object of the present invention to provide a new and improved reversible lock follower assembly for a mortise lock that is inexpensive to manufacture and non-cumbersome to operate.

It is yet a further object of the present invention to provide a new and improved reversible lock follower assembly for a mortise lock that is reversible without any disassembly of the mortise housing.

It is yet still a further object of the present invention to provide a new and improved reversible lock follower assembly that requires no components external to the housing of the mortise lock.

It is another object of the present invention to provide a new and improved reversible lock follower assembly for a mortise lock that prevents undesired tampering.

Other objects and advantages of the present invention will become apparent from the specifications and the drawings.

### SUMMARY OF THE INVENTION

Briefly stated and in accordance with the preferred embodiment of the present invention, a reversible lock follower assembly for a mortise lock having a housing for accommodating the mortise lock components and a front plate for attachment to an edge of a door is described that allows for selective reversibility of the lock follower assembly without any disassembly of the mortise lock housing. The reversible lock follower assembly comprises: (i) a follower body having a side facing the front plate and an opposite side having a bore; (ii) a coil spring placed in the bore; (iii) a follower ball engaged with the coil spring; (iv) a follower locking piece selectively movable within a slot of the follower body having a spindle hub engaging end and a follower body engaging end; and (v) a first aperture on the follower body engaging end to receive the follower ball when the locking piece is in a first position and a second aperture on the follower body engaging end to receive the follower ball when the locking piece is in a second position. In operation, the installer will move the follower locking piece to one of the first and second positions by accessing the follower locking piece through a cut-out on the housing.

### BRIEF DESCRIPTION OF THE DRAWINGS

While the specification concludes with claims particularly pointing out and distinctly claiming the subject matter regarded as the invention herein, it is believed that the present invention will be more readily understood upon consideration of the description, taken in conjunction with the accompanying drawings, wherein:

FIG. 1 is a schematic illustration of a side view of a mortise lock housing incorporating the reversible lock follower assembly of the present invention;

FIG. 2 is a cross-sectional view of the reversible lock follower assembly of the present invention taken along directional line A-A of FIG. 1;

FIG. 3 is a schematic illustration of a cross-sectional view of the lock follower assembly in accordance with the present invention;

FIG. 4 is an exploded view of the reversible lock follower assembly in accordance with the present invention; and

FIG. 5A and FIG. 5B are schematic illustrations of the reversible lock follower assembly of the present invention wherein the follower locking piece is shown in its first position (FIG. 5A) and its second position (FIG. 5B).

### DESCRIPTION OF THE PREFERRED EMBODIMENT

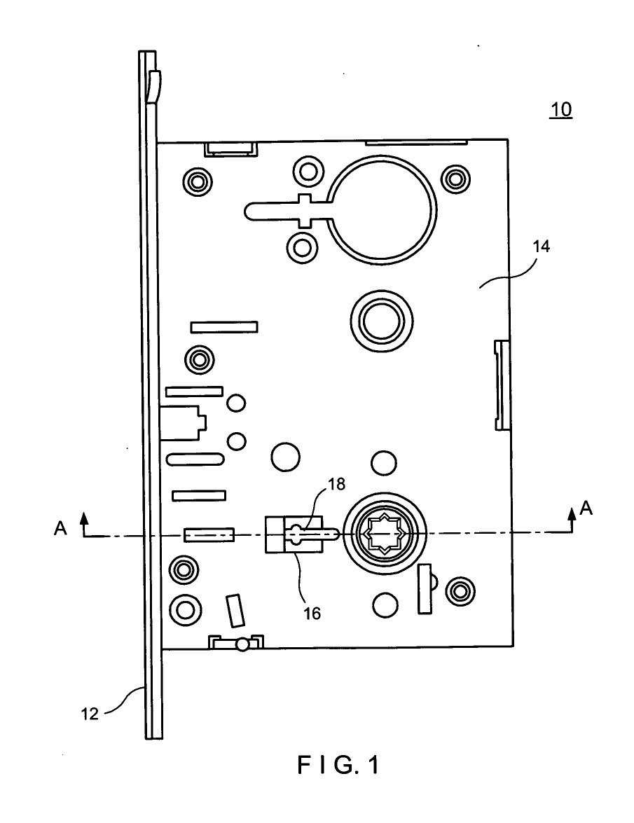

Referring first to FIG. 1, a mortise lock assembly generally designated 10 is depicted. Mortise lock assembly 10 includes a front plate 12 and a housing 14. Housing 14 is typically comprised of metal, but other materials may be used. Although not depicted since such components are well known in the art, front plate 12, which is secured to a mortised edge of a door, includes apertures for a retractable latch bolt, a retractable auxiliary bolt, a retractable deadbolt, and a lock follower, and bores to screw faceplate 12 to an edge of the door. Metal housing 14 includes a cut-out 16 that allows access to a follower locking piece 18 as will be described in more detail below.

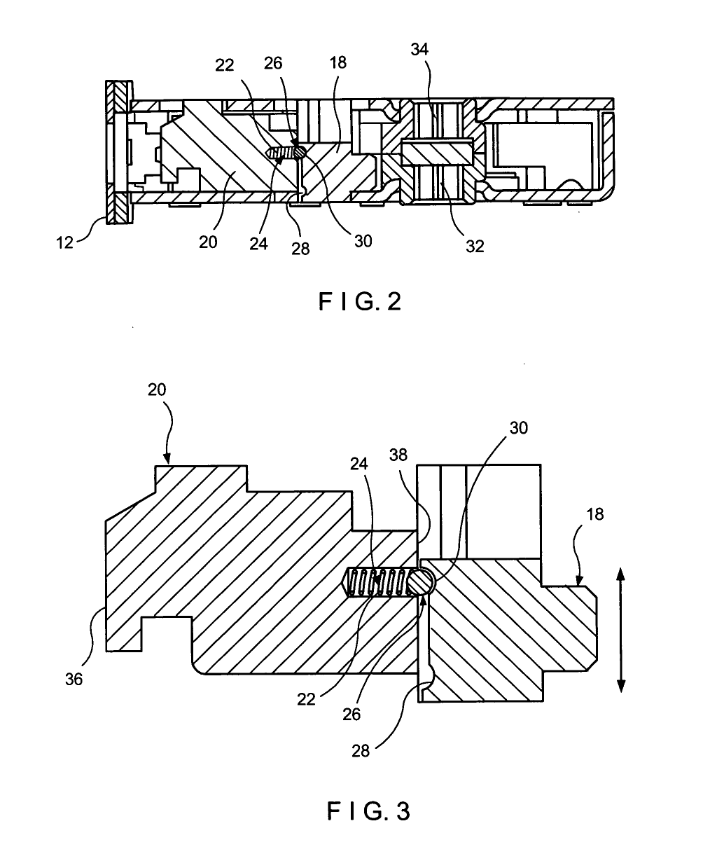

Turning next to FIG. 2, a cross-sectional view along directional lines A-A of FIG. 1 is shown. A follower body 20 includes a bore 22 upon which a coil spring 24 is placed that engages a metal ball 26. Biased tension on ball 26 from coil spring 24 allows ball 26 to selectively engage in either a first substantially semi-circular aperture 28 or a second substantially semi-circular aperture 30. As depicted in FIG. 2, ball 26 is selectively secured within aperture 30. In this orientation, follower locking piece 18 locks a bottom spindle hub 32. Conversely, if ball 26 is selectively engaged within aperture 28, a top spindle hub 34 will become locked. It is well understood in the art how spindle hub 32 and spindle hub 34 can be independently engaged to permit retraction or extension of a latch bolt.

The operation of the reversible lock follower assembly of the present invention is more readily visible in FIG. 3. Follower body 20 has a first side 36 that faces front plate 12 and an opposite side 38 that includes bore 22. Coil spring 24 is placed within bore 22 to provide outward pressure on ball 26. As shown in FIG. 3, follower locking piece 18 can be moved up or down so that ball 26 selectively engages with either aperture 28 or aperture 30. Access to allow movement of follower locking piece 18 between its first position and its second position is provided by means of cut-out 16 of housing 14 (as shown in FIG. 1).

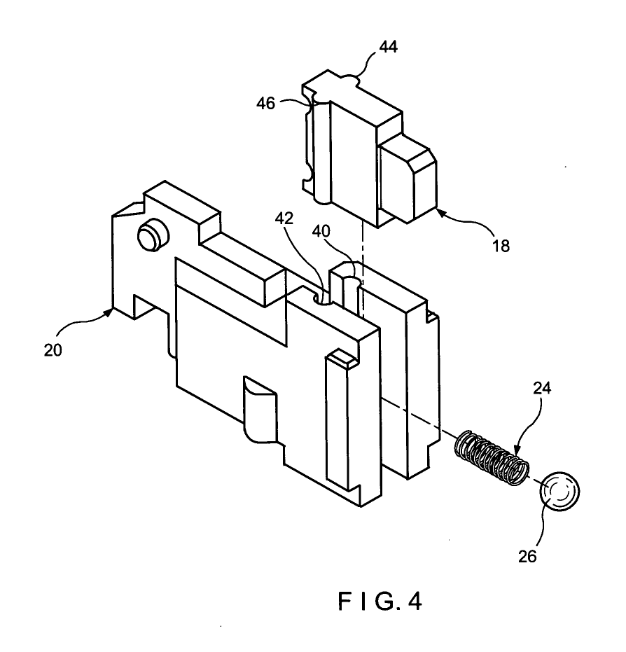

For illustrative purposes, the components comprising the reversible lock follower assembly of the present invention are shown in an exploded manner in FIG. 4. Once again, follower locking piece 18, follower body 20, coil spring 24 and metal ball 26 are depicted. It can also be seen that follower body 20 is shaped to include grooves 40 and 42 to receive matching flanges 44 and 46 on follower locking piece 18. The interconnection between flanges 44 and 46 within grooves 40 and 42 prevents the tensile strength of coil spring 24 from pushing follower locking piece 18 outside of follower body 20. It will also be noted that, although follower locking piece 18 is shown outside of follower body 20 in FIG. 4, in actual operation this will not typically occur since ball 26 will be spring loaded into either aperture 28 or aperture 30. Thus, in operation, the movement of follower locking piece 18 is typically restricted in both a lateral and vertical manner to prevent follower locking piece 18 from disengaging from follower body 20.

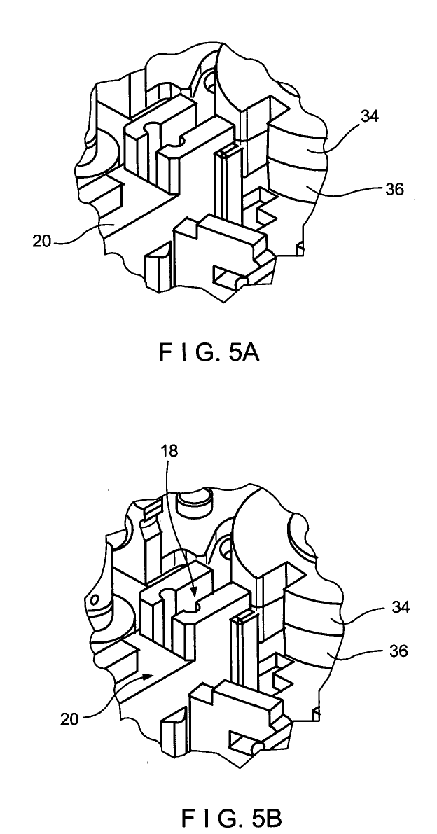

FIG. 5A and FIG. 5B depicts follower locking piece 18 in both its first position and its second position. In order to move follower locking piece 18 from one position to the other position, an installer can simply push follower locking piece 18 in one direction or another through cut-out 16 on housing 14. In order to permit easy movement of follower locking piece 18, cut-out 16 is on two sides of housing 14 (i.e., the visible side of FIG. 1 and the opposite underlying side).

It will be apparent from the foregoing description that the present invention provides a new and improved reversible lock follower assembly for a mortise lock. While a specific embodiment has been described, many variations may be utilized and are envisioned. For instance, although a coil spring and ball embodiment has been shown, other tensile biased engagement means are available. For instance, there are unitary plunger and ball devices that can be readily incorporated into the present invention. Moreover, although apertures 28 and 30 have been depicted as being substantially semi-circular in shape, it is foreseeable that other shapes can be utilized. The only requirement would be that the tensile biased engagement means coupled to the follower body can selectively engage with the mating means of the follower body engaging end of the follower locking piece. Similarly, although grooves 40 and 42 and flanges 44 and 46 have also been depicted in a substantially semi-circular shape, countless other variations in shapes can be utilized.

The reversible lock follower assembly and method can be utilized in conjunction with various means of reversing the lock bolt. The reversible follower lock assembly of the present invention controls operation by engagement of the independent spindle hubs; the actual latch bolts in operative contact with the spindle hubs are numerous. One advantageous aspect of the present invention is that, although the mortise lock can be reversed without disassembly of the mortise lock housing or the use of any specialized tools, the movement of the follower locking piece can not be achieved through the face plate alone. Thus, the possibility of tampering is greatly reduced.

While there has been shown and described what is presently considered to be the preferred embodiment of this invention, it will be obvious to those skilled in the art that various changes and modifications can be made without departing from the broader aspects of this invention. For instance, although a pair of apertures has been described in conjunction with a single tensile biased engagement means, it would be substantially equivalent to utilize a single aperture in conjunction with a pair of tensile biased engagement means. Similarly, it is foreseen that instead of placing the apertures on the follower locking piece and the tensile biased engagement means on the follower body, the apertures can be placed on the follower body and the tensile biased engagement means on the follower locking piece.

It is therefore, aimed in the appended claims to cover all such changes and modifications as fall within the true scope and spirit of the invention.

We claim:

1. A reversible lock follower assembly for a mortise lock having a housing for accommodating the mortise lock components and a front plate for attachment to an edge of a door comprising:
a follower body having a side facing the front plate and an opposite side having a bore;
a spring placed in the bore;
a follower ball engaged with the spring;
a follower locking piece selectively movable within a slot of the follower body having a spindle hub engaging end and a follower body engaging end; and
a first aperture on the follower body engaging end to receive the follower ball when the locking piece is in a first position and a second aperture on the follower body engaging end to receive the follower ball when the locking piece is in a second position, whereby the follower locking piece is selectively movable between its first position and its second position without disassembly of the housing.

2. The reversible lock follower assembly of claim 1 wherein the spindle hub engaging end of the follower locking piece engages a first spindle hub in its first position and the spindle hub engaging end of the follower locking piece engages a second spindle hub in its second position.

3. The reversible lock follower assembly of claim 1 wherein the first and second apertures are substantially semi-circular in shape.

4. The reversible lock follower assembly of claim 1 wherein the ball is comprised of metal.

5. The reversible lock follower assembly of claim 1 wherein the housing includes a cut-out to access and move the follower locking piece.

6. The reversible lock follower assembly of claim 1 wherein the follower locking piece comprises a flange shaped to movably engage within the slot of the follower body.

7. A reversible lock follower assembly for a mortise lock having a housing for accommodating the mortise lock components and a front plate for attachment to an edge of a door comprising:
a follower body having a side facing the front plate and an opposite side having a bore;
tensile biased engagement means placed in the bore;
a follower locking piece selectively movable within a slot of the follower body having a spindle hub engaging end and a follower body engaging end; and
first mating means on the follower body engaging end to receive the engagement means when the locking piece is in a first position and second mating means on the follower body engaging end to receive the engagement means when the locking piece is in a second position, whereby the follower locking piece is selectively movable between its first position and its second position without disassembly of the housing.

8. The reversible lock follower assembly of claim 7 wherein the spindle hub engaging end of the follower locking piece engages a first spindle hub in its first position and the spindle hub engaging end of the follower locking piece engages a second spindle hub in its second position.

9. The reversible lock follower assembly of claim 7 wherein tensile biased engagement means comprises a spring and a ball.

10. The reversible lock follower assembly of claim 7 wherein the tensile biased engagement means comprises a unitary plunger and ball.

11. The reversible lock assembly of claim 7 wherein the first mating means is a first aperture and the second mating means is a second aperture.

12. The reversible lock follower assembly of claim 9 wherein the ball is comprised of metal.

13. The reversible lock assembly of claim 11 wherein the first and second apertures are substantially semi-circular in shape.

14. The reversible lock follower assembly of claim 7 wherein the follower locking piece comprises a flange shaped to movably engage within the slot of the follower body.

15. The reversible lock follower assembly of claim 6 wherein the housing includes a cut-out to access and move the follower locking piece.

16. A method of reversing the orientation of a lock follower assembly for a mortise lock having a housing for accommodating the mortise lock components and a front plate for attachment to an edge of a door, wherein the lock follower assembly comprises a follower body having a side facing the front plate and an opposite side having a bore, tensile biased engagement means placed in the bore, a follower locking piece selectively movable within a slot of the follower body having a spindle hub engaging end and a follower body engaging end, and first mating means on the follower body engaging end to receive the engagement means when the locking piece is in a first position and second mating means on the follower body engaging end to receive the engagement means when the locking piece is in a second position, whereby the follower locking piece is selectively movable between its first position and its second position, the method comprising the step of:
moving the follower locking piece to one of the first and second positions by accessing the follower locking piece through a cut-out on the housing, whereby the follower locking piece is selectively movable between its first and second positions without disassembly of the housing.

17. A reversible lock follower assembly for a mortise lock having a housing for accommodating the mortise lock components and a front plate for attachment to an edge of a door comprising a follower body having a side facing the front plate and an opposite side having a bore, a spring placed in the bore; a follower ball engaged with the spring; a follower locking piece selectively movable within a slot of the follower body having a spindle hub engaging end and a follower body engaging end, and a first aperture on the follower body engaging end to receive the follower ball when the locking piece is in a first position and a second aperture on the follower body engaging end to receive the follower ball when the locking piece is in a second position, whereby the follower locking piece is selectively movable between its first position and its second position, the method comprising the step of:
moving the follower locking piece to one of the first and second positions by accessing the follower locking piece through a cut-out of the housing, whereby the follower locking piece is selectively movable between its first and second positions without disassembly of the housing.

18. A reversible lock follower assembly for a mortise lock having a housing for accommodating the mortise lock components and a front plate for attachment to an edge of a door comprising:
a follower body having a side facing the front plate and an opposite side;
a follower locking piece selectively movable within a slot of the follower body having a spindle hub engaging end and a follower body engaging end; and
tensile biased engagement means and corresponding first and second mating means positioned on opposing sides of the follower body engaging end of the follower locking piece and the opposite side of the follower body, whereby the follower locking piece is selectively movable, without disassembly of the housing, between a first position when the tensile biased engagement means is engaged with the first mating means and a second position when the tensile biased engagement means is engaged with the second mating means.

19. The reversible lock follower assembly of claim 18 wherein the spindle hub engaging end of the follower locking piece engages a first spindle hub in its first position and the spindle hub engaging end of the follower locking piece engages a second spindle hub in its second position.

20. The reversible lock follower assembly of claim 18 wherein tensile biased engagement means comprises a spring and a ball.

21. The reversible lock follower assembly of claim 18 wherein the tensile biased engagement means comprises a unitary plunger and ball.

22. The reversible lock assembly of claim 18 wherein the first mating means is a first aperture and the second mating means is a second aperture.

23. The reversible lock follower assembly of claim 20 wherein the ball is comprised of metal.

24. The reversible lock assembly of claim 22 wherein the first and second apertures are substantially semi-circular in shape.

25. The reversible lock follower assembly of claim 18 wherein the follower locking piece comprises a flange shaped to movably engage within the slot of the follower body.

26. The reversible lock follower assembly of claim 18 wherein the housing includes a cut-out to access and move the follower locking piece.

27. A reversible lock follower assembly for a mortise lock having a housing for accommodating the mortise lock components and a front plate for attachment to an edge of a door comprising:
a follower body having a side facing the front plate and an opposite side;
a follower locking piece selectively movable within a slot of the follower body having a spindle hub engaging end and a follower body engaging end; and
first and second tensile biased engagement means and corresponding mating means positioned on opposing sides of the follower body engaging end of the follower locking piece and the opposite side of the follower body, whereby the follower locking piece is selectively movable, without disassembly of the housing, between a first position when the first tensile biased engagement means is engaged with the mating means and a second position when the second tensile biased engagement means is engaged with the mating means.

28. The reversible lock follower assembly of claim 27 wherein the spindle hub engaging end of the follower locking piece engages a first spindle hub in its first position and the spindle hub engaging end of the follower locking piece engages a second spindle hub in its second position.

29. The reversible lock follower assembly of claim 27 wherein the first and second tensile biased engagement means each comprises a spring and a ball.

30. The reversible lock follower assembly of claim 27 wherein the first and second tensile biased engagement means each comprises a unitary plunger and ball.

31. The reversible lock assembly of claim 27 wherein the mating means is an aperture.

32. The reversible lock follower assembly of claim 29 wherein the ball of each of first and second tensile biased engagement means is comprised of metal.

33. The reversible lock assembly of claim 31 wherein the aperture is substantially semi-circular in shape.

34. The reversible lock follower assembly of claim 27 wherein the follower locking piece comprises a flange shaped to movably engage within the slot of the follower body.

35. The reversible lock follower assembly of claim 27 wherein the housing includes a cut-out to access and move the follower locking piece.
